(19) United States
(12) Patent Application Publication
(10) Pub. No.: US 2008/0270244 A1
(43) Pub. Date: Oct. 30, 2008

(54) METHOD, SYSTEM AND PROGRAM TO PRESENT FOOD AND BEVEREGE MENU BY DIGITAL PORTABLE TOUCH SCREEN DISPLAY DEVICE

(76) Inventor: FARSHAD ARASTEH, Toronto, CA (US)

Correspondence Address: BARRY CHOOBIN, 193 SUITE #18, TALEGHANI, BAHARE SHOMALI, TEHRAN, 1563714311, IR

(21) Appl. No.: 12/107,785

(22) Filed: Apr. 23, 2008

Related U.S. Application Data
(60) Provisional application No. 60/913,737, filed on Apr. 24, 2007.

(51) Int. Cl. G06Q 30/00

(52) U.S. Cl. 705/15

(57) ABSTRACT

Disclosed are a method, system and program to present a food and beverage menu by digital portable touch screen display device with applicable hardware and software. The present invention can be used by patrons of restaurants, hotels, clubs, bars, and other establishments whereby customers are presented with food and beverage menu options. The present invention further discloses a digital handheld touch screen display, which is light and thin, with dimensions around one (1) inch in depth, six (6) to twelve (12) inches in width and six (6) to seventeen (17) inches in length, depending on the demands and application. The device also has a cover. With specific designed software, the device will afford patrons the opportunity to view the selections of the given establishment through text, images and videos and additional information that can be accessed by using specific pen or finger on handheld.

This application claims the benefit of U.S. Provisional Application No. 60/913,737, filed Apr. 24, 2007.

### BACKGROUND OF THE INVENTION

1. Technical Field

The present invention relates in general to an improved method, system, and program for presenting a food and beverage menu. More particularly, it relates to a method, system and program for specifying digital touch screen display menu to present food and beverage to the patrons.

2. Description of the Related Art

The global economy has made the business of selling more competitive than ever. Businesses that do not maximize customer satisfaction and profitability will typically not survive in today's markets. Businesses are therefore demanding tools and methods to provide their competitive edge.

In the area of food and beverage sales, maximizing customer satisfaction is particularly important to businesses. It is commonly recognized that making a decision of what to choose from a menu is not easy. Having information about what to eat or drink has a great impact on ones choice. Therefore, in maximizing customer satisfaction, there has been a shift towards providing the customer with menus that provide for customer needs. For example, it is hard to change the price on the conventional paper—based food and beverage menus. In addition all the information about foods and beverages can not be given to the costumers because of weight and paper limitations in conventional paper menus. Another problem is difficulty reading in a dim place with paper menus. Furthermore, seeing the high quality pictures of food and beverage has a great impact on costumer choice. Furthermore, customers may want to see how the food is cooked by short video clip, which this device could offer.

While there have been efforts to provide more information about food on a menu, it is typically difficult to know what one is eating, when dining out or purchasing preprocessed food. Some menus now include a list of some ingredients and some waiters may know the main ingredients of dish, however finding out a list of every ingredient and preparation thereof is typically not available or there is not an efficient way for the information to be provided.

Another difficulty in purchasing food for some can be the way that a menu is presented. In addition, when in a foreign country or cosmopolitan city, menus in a language understood by the customer may not be available. Moreover, when in a foreign country converting currency to determine the relative expense of an item in one's typical currency can be time consuming.

### SUMMARY OF THE INVENTION

In view of the foregoing, it is therefore an object of the present invention to provide an improved method, system and program for presenting a food and beverage menu.

It is another object of the present invention to provide a method, system and program for efficiently specifying a digital touch display screen food and beverage menu.

In accordance with the method, system and program of the present invention, food and beverage preferences for customers are requested from digital touch screen display menu, wherein a key for the customer is required to access the food and beverage preferences for the customers. With use of this innovation, every customer will have a separate digital touch screen display food and beverage menu covered with leather top or other traditional menu cover materials. This device is very light and everybody can choose items from it by reading the main page and accessing additional details using a specific pen to navigate the screen. The pen is attached to the cover and is removable. Customers can also navigate the screen selecting items with their fingers. This device works with chargeable battery.

All objects, features, and advantages of the present invention will become apparent in the following detailed written description.

### DESCRIPTION OF A PREFERRED EMBODIMENT

The present invention may be executed in a variety of systems, including a variety of computers under a number of different operating systems. The computer may be, for example, a tablet computer, a pocket pc, a personal digital assistant, a network computer, a midrange computer or a mainframe computer. In addition, the computer may be a stand-alone system or part of a network such as a local-area network (LAN) or a wide area network (WAN). In addition, the computing device preferably includes at least one output device and at least one input device.

Also, it is contained in an enclosure or frame or chassis which may be made from any materials and a touch screen display that is attached on one side. Enclosure dimensions will be built to suit in accordance with ordered demand. A processor (CPU), a read-only memory (ROM) and a Random-Access Memory (RAM) and flash memory are connected to a system bus of a computer system. The power source is a small light rechargeable litum battery. Specific software in accordance with demand will be written. For example, one vendor may want to have 3 languages, a specific diet program, advertising on the main page, or features to create one's own food options. Basically, the software is written for a list of foods and beverages with basic information like, price and ingredients. The other options that can be added to the main menu are: any languages, short video film, pictures, audio information, health program, any other information about the venue in which the menu is being used, and currency exchange information. As demonstrated by the description and example above, the inventive method and apparatus and software instructions disclosed herein allows for customer of a restaurant to communicate wirelessly with one or more attendants of a restaurant, making service requests of the attendants. The description of the present invention has been presented for purposes of illustration and description, and is not intended to be exhaustive or limited to the invention in the form disclosed. Modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

I claim:

1. A system for presenting food and beverages menu comprising:
means for graphically displaying listing and image of ingredients information of said food and beverage;
means for graphically displaying preparation of said food and beverage;
means for selecting a language for displaying said information;
means for accessing food and beverage preferences for a customer;
means for selecting food and beverage preferences for a customer;
means for transmitting at least one preference selected from said food and beverages preference to a host computer.

2. A system as claimed in claim 1, wherein said language is selected from a group of languages consisting of at least English, Farsi, Chinese, French and German.

3. A System as claimed in claim 2, wherein said system is a handheld portable device.

4. A system as claimed in claim 2, wherein said selecting is made by a digital pen.

5. A system as claimed in claim 2, wherein said selecting is made on a touch screen display.

6. A system as claimed in claim 2, wherein said selecting is made by human finger.

7. A method for presenting food and beverages menu comprising:
graphically displaying listing and image of ingredients information of said food and beverage;
graphically displaying preparation of said food and beverage;
selecting a language for displaying said information;
accessing food and beverage preferences for a customer;
selecting food and beverage preferences for a customer;
transmitting at least one preference selected from said food and beverages preference to a host computer.

8. A method as claimed in claim 7, wherein said language is selected from a group of languages consisting of at least English, Farsi, Chinese, French and German.

9. A method as claimed in claim 8, wherein said method performed by a handheld portable device.

10. A method as claimed in claim 8, wherein said selecting is made by a digital pen.

11. A method as claimed in claim 8, wherein said selecting is made on a touch screen display.

12. A method as claimed in claim 8, wherein said selecting is made by human finger.

13. A program, residing on a computer usable medium having computer readable program code means, said program comprising:
means for retrieving and displaying listing and image of ingredients information of said food and beverage;
means for graphically displaying preparation of said food and beverage;
means for selecting a language for displaying said information, wherein said language is selected from a group of languages consisting of at least English, Farsi, Chinese, French and German;
means for accessing food and beverage preferences for a customer;
means for accessing and selecting food and beverage preferences for a customer;
means for transmitting at least one preference selected from said food and beverages preference to a host computer.
